(19) United States
(12) Patent Application Publication
(10) Pub. No.: US 2025/0092201 A1
(43) Pub. Date: Mar. 20, 2025

(54) ULTRA TOUGH GLASSY THERMOSET SYNTHESIZED USING A CURABLE LIQUID RESIN

(71) Applicant: University of Utah Research Foundation, Salt Lake City, UT (US)

(72) Inventors: Caleb Reese, Salt Lake City, UT (US); Chen Wang, Salt Lake City, UT (US)

(21) Appl. No.: 18/884,788

(22) Filed: Sep. 13, 2024

Related U.S. Application Data
(60) Provisional application No. 63/625,572, filed on Jan. 26, 2024.
(60) Provisional application No. 63/583,088, filed on Sep. 15, 2023.

(51) Int. Cl. C08G 75/045; B33Y 70/00; C09D 181/02

(52) U.S. Cl. CPC C08G 75/045; B33Y 70/00; C09D 181/02; C08G 2250/00

(57) ABSTRACT

Disclosed herein are polyamide substrates that may be reliably used in additive manufacturing to produce a wide variety of 3D printed articles, protective films or membranes. The polyamide substrate can be formed via thiol-ene click chemistry reactions between diallyl amide or other alkene monomers, reacted with thiol monomers, that can be activated by photoirradiation at relatively low temperatures (e.g., about 80° C.). As a result, the polyamide substrates disclosed herein may be cured using a simple, energy efficient curing process that allows for additive manufacturing where the produced 3d printed article exhibits increased toughness rather than being brittle as are most 3d printed articles.

### CROSS-REFERENCE TO RELATED APPLICATIONS

This application claims the benefit of and priority to each of U.S. Provisional Patent Application Ser. No. 63/625,572 filed on Jan. 26, 2024, and entitled “ULTRA TOUGH GLASSY THERMOSET SYNTHESIZED USING A CURABLE LIQUID RESIN,” and U.S. Provisional Patent Application Ser. No. 63/583,088 filed Sep. 15, 2023 and entitled “ULTRA TOUGH GLASSY THERMOSET SYNTHESIZED USING A CURABLE LIQUID RESIN,” each of which is expressly incorporated herein by reference in its entirety.

### STATEMENT REGARDING FEDERALLY SPONSORED RESEARCH OR DEVELOPMENT

N/A.

### FIELD OF THE INVENTION

The present invention generally relates to tough (as opposed to brittle), glassy thermoset materials synthesized using a curable liquid resin. For example, more specifically, an embodiment of the invention relates to thermoset materials including polyamide substrates that can be synthesized with UV light, e.g., for formation of unique shapes that exhibit toughness and ductility, shape-memory, and other advantageous properties.

### BACKGROUND

Linear polymers, or thermoplastics, make up most single-use plastics, given their outstanding mechanical properties, including high strength and the ability to undergo extensive deformation before breaking. However, they exhibit poor recovery from large plastic deformations. On the other hand, network polymers have covalently crosslinked three-dimensional structures that endow them with excellent dimensional stability, resistance to heat and solvents, and the ability to recover from deformations (i.e., shape-memory effect). Nevertheless, network polymers can sometimes be brittle, which can be problematic for many uses. Network polymers, or thermosets, are ubiquitous in many applications, including but not limited to tires, fiber-reinforced composites, hydrogels, and various coatings. Neat network polymers typically fall into two categories: rubbery network polymers, also known as elastomers, with a glass transition temperature (T_{g}) below ambient temperature, and glassy network polymers, with a T_{g} above ambient temperature. While elastomers can recover their original shape and material properties from large deformations (e.g., >100% strain), glassy network polymers are notoriously brittle and typically fracture with <5% strain. Accordingly, ductility—a material's capability of sustaining plastic deformation under tensile stress before failure—has yet to be achieved in glassy network polymers. Such materials are routinely used in additive manufacturing (3d printing), and the brittleness and lack of toughness for such materials is a significant problem.

There remains a need to develop new glassy network polymers to advance polymer science and materials by providing new plastics with a combination of desirable attributes, such as increased toughness for materials useful in additive manufacturing.

### SUMMARY

The present disclosure relates to curable thermoset resins that upon curing exhibit low brittleness, high toughness, and flexibility upon polymerization, similar to a thermoplastic resin, e.g., in at least some embodiments without inclusion or use of polyurethanes, polyureas, cyanates, and/or isocyanates. In an embodiment, such a material is embodied in a polyamide substrate with thiol linkages combined with high performance amide linkages to make a polymer that can be processed with light (e.g., UV or visible light), heat, and/or thermal radical generating catalysts into many shapes and form factors. The resulting glassy network polymers may be crystalline or semi-crystalline and exhibit significantly improved ductility and shape-memory actuation.

In one embodiment, a polyamide substrate is formed from diallyl amide or other difunctional alkene monomers and thiol monomers, with resulting thioether linkages between the diallyl amide or other difunctional alkene monomers and the thiol monomers, wherein the diallyl amide or other difunctional alkene monomers and the thiol monomers polymerize to form the polyamide substrate. The thiol monomers may comprise ester linkages, wherein the ester linkages are degradable under mild conditions.

While difunctional alkene monomers including an amide group are particularly contemplated, other reactive groups may also be possible. For example, in some embodiments, the difunctional amide monomers comprise monomers with reactive groups including, but not limited to allyl, alkene, acrylate, methacrylate, epoxy, thiol, norbornene, and/or bisimides. In some embodiments, the amide monomers comprise monomers with ortho, para, or meta substituted reactive groups.

For example, in some embodiments, the difunctional amide monomers comprise alkyl divinyl amide monomers such as N-allyl-4-pentenamide, N-allyl-3-butenamide, N-vinyl, and/or N-allyl-5-hexenamide.

In some embodiments, the one or more thiol monomers comprise dithiol monomers, trithiol monomers, or a mixture thereof.

In some embodiments, the thiol monomers may comprise ethylene bis(3-mercaptopropionate) (EBMP), trimethylolpropane tris 3-mercaptopropionate (TMPMP), ethylene glycol di(3-mercaptopropionate) (GDMP), tris [2-(3-mercaptopropionyloxy) ethyl] isocyanurate (TEMPIC), ethane-1,2-dithiol (EDT), 1,2 ethylene dithiol (2DT), 1,3 propanedithiol (3DT), 1,4 butanedithiol (4DT), 1,5 pentanedithiol (5DT), 1,6 hexanedithiol (6DT), 1,7 heptanedithiol (7DT), 1-8 octanedithiol (8DT), 1-9 nonanedithiol (9DT), 1-10 dodecanedithiol (10DT), and/or pentaerythritol tetra(3-mercaptopropionate) (PETMP).

A method of synthesizing and curing a polyamide substrate involves providing diallyl amide or other alkene monomers and thiol monomers, if needed, heating the diallyl amide or other alkene and thiol monomers to form a liquid resin comprising melted diallyl amide or other alkene monomers and melted thiol monomers, and curing the liquid resin with UV light, visible light, heat, and/or a thermal radical generating catalyst. If all monomers are liquids (e.g., oils) at ambient temperature (e.g., N-allyl-4-pentenamide) or reactive diluents are used, no heating or melting is required for the synthesis. If desired, the liquid resin could be placed within a mold (e.g., a heated mold) to produce a desired shape. Because of the relatively low melting point of the diallyl amide or other difunctional alkene monomers and the thiol monomers, the liquid resin may remain liquid for an amount of time sufficient to easily transfer the liquid resin to a heated mold. By way of example, the monomers may have a melting point of less than about 220° C., less than about 200° C., less than about 150° C., or less than about 100° C. In an embodiment, one or more of the selected monomers may be liquid under ambient conditions (e.g., melting point of less than about 30° C., 25° C., or 20° C.). Advantageously, in an embodiment, no solvents may be needed or present, and the process may not involve the generation (and required removal) of volatile byproducts, such as ethylene glycol.

The disclosed embodiments may be used in a wide variety of additive manufacturing (e.g., 3D printing) processes. Examples include but are not limited to stereolithography, digital light processing, continuous liquid interface production, polyjet, and other techniques that involve the use of photocurable resin materials. The disclosed embodiments advantageously provide superior mechanical toughness for the 3D printed components.

The disclosed embodiments may also be utilized to manufacture protective thin films, such as coatings and adhesives. The curable liquid resin may typically have low viscosity (e.g., less than about 10,000 cps, less than 5,000 cps, less than 1000 cps, less than about 750 cps, less than about 500 cps, less than about 400 cps, less than about 300 cps, less than about 200 cps, or less than about 100 cps under standard temperature and pressure conditions) which allows straightforward deposition of the resin as thin layers of liquids.

While principally described in terms of monomers used in forming the described polymers, it will be appreciated that larger polymerizable components can also be used and are within the scope of the intended meaning of “monomer” or “monomers”. For example, dimers, trimers, oligomers, and other polymerizable components having the described functional groups are also contemplated, and within the scope of the meaning of “monomer” or “monomers” as used herein.

In any of the described embodiments, exemplary aromatic diallyl amide monomers may comprise at least one of meta-substituted diallyl amide monomers, ortho-substituted diallyl amide monomers, para-substituted diallyl amide monomers, or alkyl diallyl amide monomers (e.g., N-allyl-4-pentenamide, N-allyl-3-butenamide, N-vinyl, and/or N-allyl-5-hexenamide). A wide variety of other difunctional alkene amide monomers may also or alternatively be used.

In any of the described embodiments, the one or more thiol monomers may comprise at least one of trimethylolpropane tris 3-mercaptopropionate (TMPMP), ethylene glycol di(3-mercaptopropionate) (GDMP), or pentaerythritol tetra(3-mercaptopropionate) (PETMP), and/or a C2-C10 alkyl dithiol compound.

In any of the described embodiments, any of the employed monomers may have a melting point of less than about 220° C., less than about 200° C., less than about 150° C., or less than about 100° C.

In any of the described embodiments, the polyamide substrate may be cross-linked.

In any of the described embodiments, the polyamide substrate may have a glass transition temperature from about −50° C. to about 100° C., from about −45° C. to about 90° C., −35° C. to about 80° C. from about −25° C. to about 70° C., from about −20° C. to about 60° C., or from about 30° C. to about 70° C.

In some embodiments, the polymer substrate may have a Young's modulus of at least about at least about 100 MPa, at least about 500 MPa, at least about 1000 MPa, at least about 1050 MPa, at least about 1100 MPa, at least about 1150 MPa, no more than about 3000 MPa, no more than about 2500 MPa, no more than about 2000 MPa, no more than about 1500 MPa, no more than about 1400 MPa, no more than about 1300 MPa, or no more than about 1250 MPa. Some relatively softer embodiments may have a Young's modulus of at least about 100 MPa, such as from about 100 MPa to about 1000 MPa, or from about 100 MPa to about 500 MPa.

In any of the described embodiments, the polymer substrate may have a tensile strength of at least about 20 MPa, at least about 25 MPa, at least about 30 MPa, at least about 35 MPa, at least about 40 MPa, or at least about 45 MPa, no more than about 100 MPa, no more than about 80 MPa, or no more than about 75 MPa.

In some of the described embodiments, the polymer substrate may be degraded using a transesterification reaction stimulated at or near ambient temperature (e.g., less than 50° C., less than 40° C. or from about 10° C. to about 35° C.).

In some of the described embodiments, the transesterification reaction may be stimulated with a methanol or other alcohol solution. In an embodiment, some portion of dichloromethane (DCM), e.g., about 50% by weight or volume, may be present in the solution. An alkali metal carbonate or variety of other catalysts, e.g., potassium carbonate (K₂CO₃) may be used during such transesterification.

In any of the described embodiments, the first polyamide film and the second polyamide film may comprise diallyl amide monomer polymerization residues, thiol monomer polymerization residues, and thioether linkages between the diallyl amide or other difunctional alkene monomer polymerization residues and the thiol monomer polymerization residues, where the diallyl amide monomer or other difunctional alkene monomer polymerization residues and the thiol monomer polymerization residues are polymerized to form the flexible polymer substrate. The thiol monomer polymerization residues may comprise ester linkages which are degradable under mild conditions.

Applicant's U.S. patent application Ser. No. 18/737,657 filed Jun. 7, 2024 and entitled “DEGRADABLE POLYIMIDES FOR FLEXIBLE ELECTRONIC SUBSTRATES USING THIOL-ENE CLICK CHEMISTRY” is also herein incorporated by reference in its entirety. While such application is generally directed to polyimides, many of the concepts described therein can be adapted, for use in the polyamides of the present disclosure. Such embodiments incorporating such adaptations are within the scope of the present disclosure.

Features from any of the disclosed embodiments may be used in combination with one another, without limitation. This summary is provided to introduce a selection of concepts in a simplified form that are further described below in the detailed description. This summary is not necessarily intended to identify key or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the components and combinations particularly pointed out in the appended claims. These and other features of the present disclosure will become more fully apparent from the following description and appended claims, or may be learned by the practice of the disclosure as set forth hereinafter.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIGS. 1A-1L illustrate exemplary monomers that can be used to form a polyamide substrate according to the present disclosure.

FIG. 2A schematically illustrates a system of providing different ratios of dithiol and trithiol monomers when producing an exemplary polyamide substrate.

FIG. 2B schematically illustrates an exemplary stable resin including a mixture of monomers before curing.

FIG. 2C schematically illustrates an exemplary polyamide network with covalent crosslinking as well as interchain hydrogen bonding.

FIG. 3 illustrates an exemplary method of synthesizing and curing a polyamide substrate.

FIG. 4 illustrates FTIR analysis of an exemplary polyamide substrate.

FIG. 5A illustrates a table showing exemplary physical characteristics of several polyamide substrates formed according to the present disclosure.

FIG. 5B illustrates monomers used to synthesize thiol-ene polymers for comparative testing of physical properties.

FIGS. 5C-5D illustrate results of comparative testing.

FIG. 6 illustrates an exemplary method of additive manufacturing using the polyamide materials disclosed herein.

FIGS. 7A-7C illustrate an exemplary synthesis of diallyl para-phthalamide monomers wherein FIG. 7A illustrates an exemplary synthesis reaction, FIG. 7B illustrates the proton nuclear magnetic resonance (¹H NMR) spectrum of the product of the synthesis, and FIG. 7C illustrates the carbon nuclear magnetic resonance (¹³C NMR) spectrum of the product of the synthesis.

FIGS. 8A-8C illustrate an exemplary synthesis of diallyl ortho-phthalamide monomers wherein FIG. 8A illustrates an exemplary synthesis reaction, FIG. 8B illustrates ¹H NMR spectrum of the product of the synthesis, and FIG. 8C illustrates the ¹³C NMR spectrum of the product of the synthesis.

FIGS. 9A-9C illustrate an exemplary synthesis of diallyl meta-phthalamide wherein FIG. 9A illustrates an exemplary synthesis reaction, FIG. 9B illustrates ¹H NMR spectrum of the product of the synthesis, and FIG. 9C illustrates the ¹³C NMR spectrum of the product of the synthesis.

FIG. 10 illustrates an exemplary polymerization and curing reaction of a polyamide substrate according to the present disclosure.

FIG. 11 illustrates an exemplary depolymerization reaction for a polyamide substrate according to the present disclosure.

### DETAILED DESCRIPTION

### Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “monomer” includes one, two or more monomers.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about” or its synonyms such as “approximately” or “substantially.” Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

### General Overview of Example Embodiments

Disclosed herein are various embodiments and methods related to the utilization of polyamide photopolymers. Specifically, various embodiments may comprise polyamide films comprising robust thioether linkages of varying structures and varying levels of crystallinity derived from commercially abundant chemical feedstocks. Also described are exemplary methods of synthesis, processing, and reprocessing (e.g., recyclability). The present disclosure also describes how such materials may be used in additive manufacturing, as well as preparation of protective films and membranes, where such articles include increased toughness as compared to existing alternatives.

While photopolymerization has been broadly implemented in material manufacturing given its desired attributes including fast reaction kinetics and solventless processing of low-viscosity, liquid monomers, photopolymer material properties are typically inferior to other polymers (e.g., thermoplastics) as they tend to be amorphous polymers and thus lack microstructural characteristics that might improve their physical properties. In particular, materials typically employed in additive manufacturing such as (meth)acrylate free-radical polymerization products and cationic polymerization of epoxide products are brittle, lacking toughness.

The polyamide photopolymers described herein overcome at least some of the aforementioned shortcomings of traditional photopolymers. Specifically, the polyamides described herein possess improved toughness, while also being particularly suited for use in additive manufacturing, protective films, membranes and a wide variety of other articles where such a combination of characteristics would be beneficial.

Embodiments described herein may utilize thiol-ene click chemistry as an ideal photopolymerization method for the design of polyamide networks. Despite free-radical polymerization of acrylate or methacrylate free-radical polymerization being a common choice for photopolymerization, it suffers from oxygen inhibition, often resulting in tacky surfaces due to incompletely reacted monomers, as well as such products being brittle. On the contrary, thiol-ene polymerizations have the benefit of little oxygen inhibition and are proven capable of forming thin films with non-tacky, smooth surfaces, with significantly improved toughness. These thiol-ene polymerization reactions are activated by light irradiation (e.g., UV), allowing for a simple curing process at relatively low temperatures (e.g., less than about 150° C., less than about 125° C., or less than about 100° C. such as from about 60° C. to about 100° C., from about 70° C. to about 90° C. or about 80° C.). This low curing temperature allows polyamide substrates to be deposited and cured in the presence of sensitive components that may otherwise be damaged by higher temperatures.

Furthermore, embodiments described herein may comprise or be formed from commercially available thiol monomers that possess degradable alkyl ester linkages, such as trimethylolpropane tris 3-mercaptopropionate (TMPMP), Pentaerythritol tetrakis(3-mercaptopropionate) (PETMP), Polycaprolactone tetra(3-mercaptopropionate), Dipentaerythritol Hexakis(3-mercaptopropionate), Tris[2-(3-mercaptopropionyloxy)ethyl] Isocyanurate (TEMPIC), Ethylene Glycol Bis(3-mercaptopropionate) (EBMP), Pentaerythritol tetrakis (3-mercaptobutylate), 1,4-Bis (3-mercaptobutyroyloxy) butane, 1,3,5-Tris [2-(3-mercaptobutanoyloxy) ethyl]-1,3,5-triazine-2,4,6 (1H,3H,5H)-trione, and/or Trimethylol propane tris (3-mercaptobutylate). Others are of course also possible. As a result, depolymerization of these poly(amide-ester) networks via transesterification reactions stimulated at ambient or near ambient temperatures allows successful recovery and reuse of electrical or other valuable materials that may be encapsulated or otherwise present within such polyamide films. Rather than being discarded when a device reaches its end-of-life, such valuable components may be recaptured and reused after the films are degraded. The presently described transesterification mechanisms also allow for potential recyclability of the described polymer materials.

In some embodiments, the thiol monomers described herein may possess degradable alkyl ester linkages (e.g., TMPMP, TEMPIC, EBMP, and/or others) that allow for degradation of polymer networks once the polymer substrates reach their end-of-life. Exemplary degradation procedures are described hereinbelow.

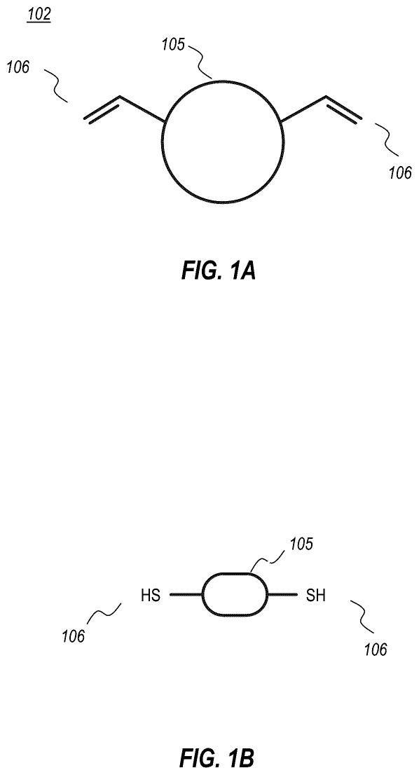

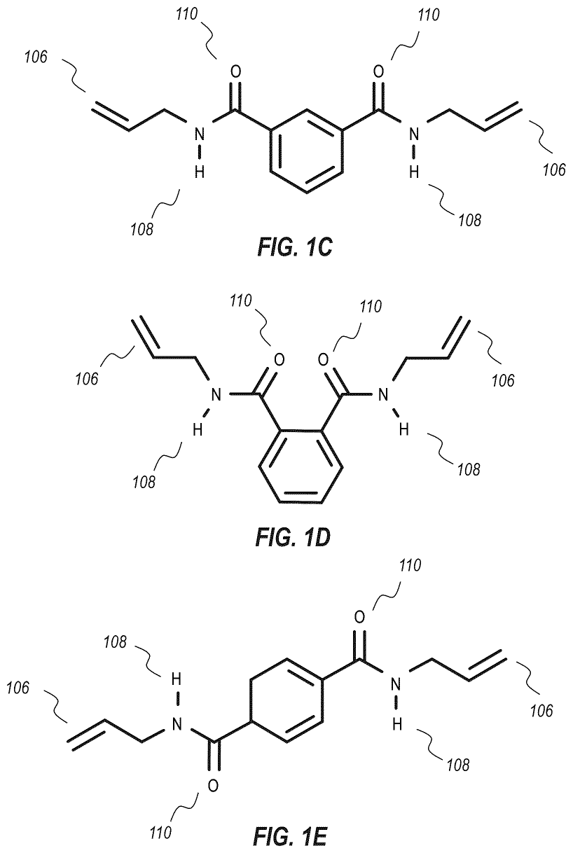

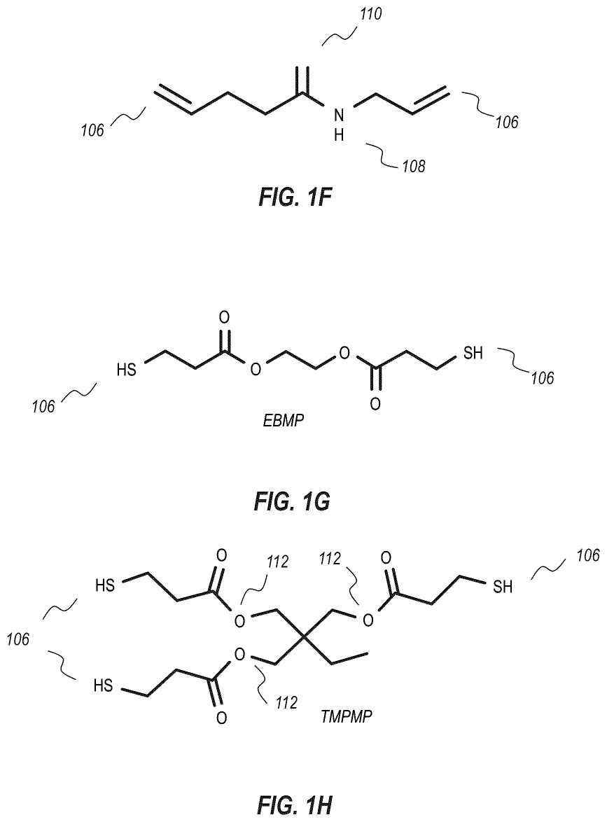

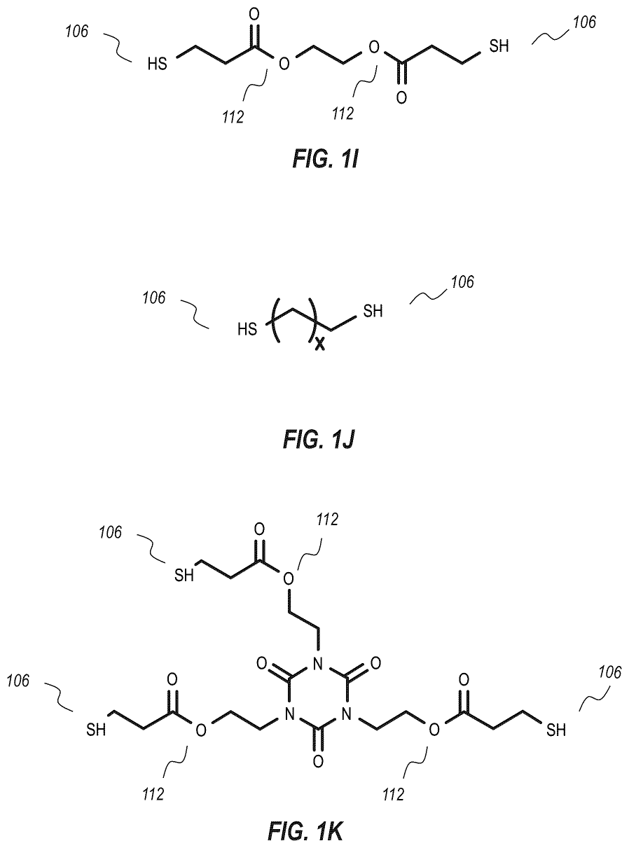

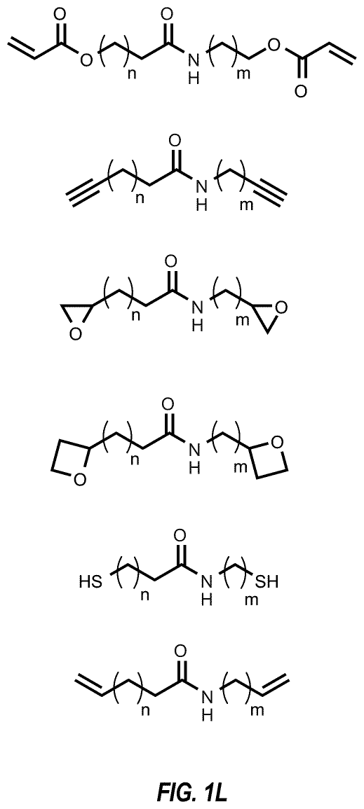

FIGS. 1A-1K illustrate exemplary chemical structures of monomers that can be used to form an exemplary polyamide photopolymer, wherein the monomers may comprise various alkene monomers 102 and thiol monomers 104. Turning now to FIG. 1A, the alkene monomers 102 may comprise reactive groups 106 and a functional core 105, wherein the functional core 105 contains one or more of various amide structures, for example, those illustrated in FIGS. 1C-1F. In some embodiments, such as those illustrated in FIGS. 1C-1E, the functional core may be a diamide, with symmetrically positioned amide groups. In some embodiments, the functional core 105 is an ortho, para, or meta substituted phthalamide. In some embodiments, the functional core 105 comprises one or more amide groups that may be asymmetrically positioned, such as the embodiment illustrated in FIG. 1F. The reactive groups 106 are illustrated in FIGS. 1A-IF as comprising allyl functional groups. However, the reactive groups 106 may comprise at least one of allyl, alkene, acrylate, methacrylate, epoxy, thiol, norbornene, and/or bisimide groups and/or other groups that allow for photopolymerization. In some embodiments, the alkene monomers 102 may comprise diallyl meta-phthalamides (see FIG. 1C), diallyl ortho-phthalamides (see FIG. 1D), and/or diallyl para-phthalamides (see FIG. 1E). In other embodiments, the alkene monomers 102 may comprise N-allyl-4-pentenamide (see FIG. 1F, or the more generic chemical structure included in FIG. 1L). Various other alkyl divinyl amide monomers are also possible (e.g., N-allyl-3-butenamide, N-vinyl, and/or N-allyl-5-hexenamide). Use of such alkyl divinyl amide monomers may result in melting temperatures for the resulting polyamide network that may range generally from about 65° C. to about 95° C., which are significantly higher than melting temperatures of polyesters. Use of such materials may result in ultimate tensile strength values of greater than about 22 MPa and elongation at break values of greater than about 400%.

While diallyl amide monomers may be principally described, it will be appreciated that a wide variety of difunctional monomers similar to or different from those shown in the Figures can also or alternatively be used. Non-limiting examples of such amides are shown in FIG. 1L. The values for m and n in FIG. 1L may be any integer value, e.g., ranging from 1 to 30, 1 to 20, or from 1 to 10, such as 1, 2, 3, 4, 5, 6, 7, 8, 9, or 10, for example. The values of m and n may be independent (e.g., the same or different) than one another.

Turning now to FIG. 1B, the thiol monomers 104 may comprise two or more reactive groups 106 and a functional core 105, wherein the functional core may include one or more of various structures. For example, the functional core may comprise one or more degradable ester linkages 112, such as shown in the embodiments illustrated in FIGS. 1H, 1I, and 1K. Ester linkages 112 may provide various embodiments of the polyamide substrates described herein with degradability, wherein a polyamide substrate may be degraded and/or reprocessed after degradation. Exemplary degradation procedures are described hereinbelow.

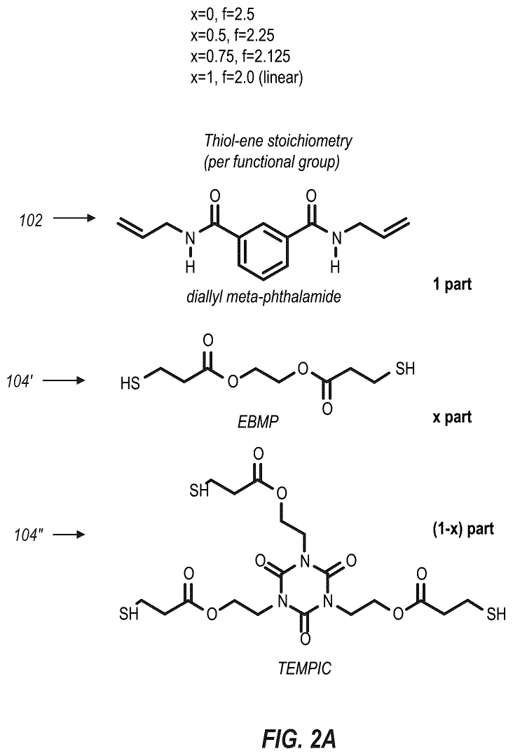

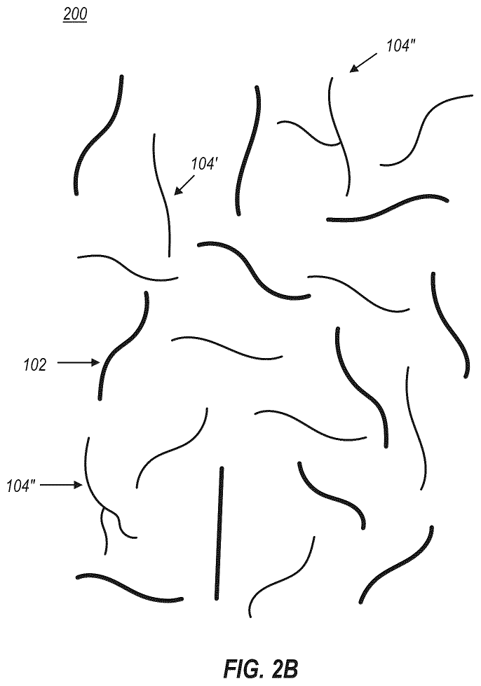

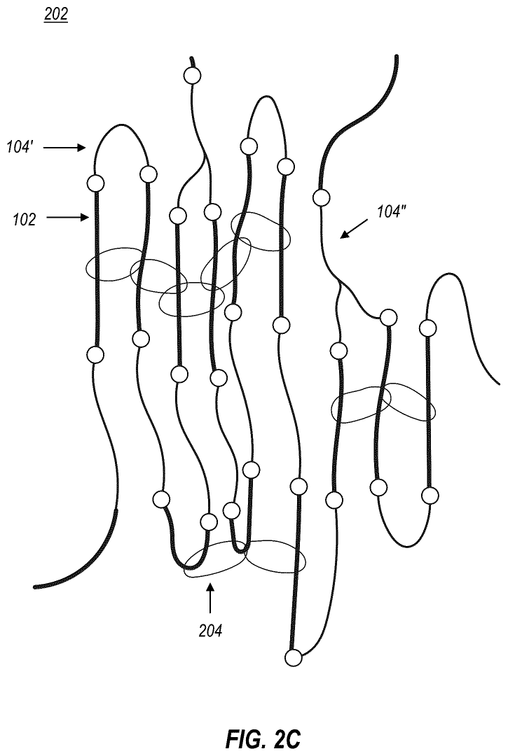

In some embodiments, the thiol monomer 104 may contain two reactive groups (e.g., a dithiol compound) or may contain three reactive groups (e.g., a trithiol compound). While thiol monomers 104 with two reactive groups introduce linear bonds to the resulting polymer network, thiol monomers 104 with three or more reactive groups may be included to introduce crosslinking to a resulting network polymer. Accordingly, trithiol monomers provide a resulting network polymer with covalently crosslinked three-dimensional structures that can provide dimensional stability, resistance to heat and solvent, and the ability to recover from deformations (i.e., shape-memory effect). Without being bound to theory, while crosslinking may seem to inhibit the formation of crystalline microstructures, limited amounts of crosslinker may be used, to provide for semi-crystalline network polymers. Accordingly, the stoichiometric amounts of dithiol and/or trithiol monomers can be adjusted in various embodiments in order to provide a desired degree of crosslinking suitable for a given application. FIG. 2A illustrates a system of designing a polyamide comprising alkene monomers 102, dithiol monomers 104′ and trithiol monomers 104″, wherein the dithiol monomers 104′ and trithiol monomers 104″ can be provided in various stochiometric ratios. As illustrated in FIG. 2A, x represents the stochiometric proportion of total thiol monomers 104 that are dithiol monomers 104′ and 1−x represents the stoichiometric proportion of total thiol monomers 104 that are trithiol monomers 104″. This system may also be expressed in terms of a mol percentage (mol %), wherein x represents the mol % of total thiol monomers that are dithiol monomers 104′ while 100%−x represents the mol % of total thiol monomers that are trithiol monomers 104′. For example, in an embodiment where dithiol monomers 104′ make up 75% of the total thiol monomers 104 provided for polymer synthesis, 25 mol % of trithiol monomers 104″ may be provided for polymer synthesis.

Varying the molar ratios between dithiols 104′ and trithiols 104″ alters the crosslinking density, which is represented by average crosslinking density (f). For example, providing a smaller proportion of dithiols 104′ compared to trithiols 104″ may result in a polyamide network with a higher crosslinking density (e.g., when x=0 and 1−x=1, average functionality (f)=2.5). As the proportion of dithiol monomers 104′ is increased compared to the proportion of trithiol monomers 104″, the crosslinking density of the resulting polymer network is decreased (e.g., when x=0.5 and 1−x=0.5, average functionality (f)=2.25). Changes in crosslinking density and related changes to microstructure (such as crystallinity) can affect the overall properties of the resulting polymer. Specific effects are described below.

In some embodiments, the thiol monomers 104 may include one or more of ethylene bis(3-mercaptopropionate) (EBMP), atris [2-(3-mercaptopropionyloxy) ethyl] isocyanurate (TEMPIC), trimethylolpropane tris(3-mercaptopropionate) (TMPMP), Pentaerythritol tetrakis(3-mercaptopropionate) (PETMP), Polycaprolactone tetra(3-mercaptopropionate), Dipentaerythritol Hexakis(3-mercaptopropionate), Pentaerythritol tetrakis (3-mercaptobutylate), 1,4-Bis (3-mercaptobutyroyloxy) butane, 1,3,5-Tris [2-(3-mercaptobutanoyloxy) ethyl]-1,3,5-triazine-2,4,6 (1H,3H,5H)-trione, and/or Trimethylol propane tris(3-mercaptobutylate), for example. Combinations of such or other thiol monomers may also be used.

For example, in some embodiments, such as the embodiment illustrated in FIG. 1J, the thiol monomers 104 may additionally or alternatively include thiol monomers 104 wherein the functional core 105 of the thiol monomer 104 comprises an alkyl chain such as a C2-C16 alkyl chain, wherein subscript x is a modifier that may be any number of carbons in such an alkyl chain. For example, the alkyl chain may be a C2-C10 alkyl chain (i.e., x=1-9), such as a C2-C5 alkyl chain, or a C6-C10 alkyl chain. Resulting molecules may include 1,2-ethanedithiol (2DT), 1,3-propanedithiol (3DT), 1,4-butanedithiol (4DT), 1,5-pentanedithiol (5DT), 1,6-hexanedithiol (6DT), 1,7-heptanedithiol (7DT), 1,8-octanedithiol (8DT), 1,9-nonanedithiol (9DT), 1,10-dodecanedithiol (10DT), and/or other alkyldithiol compounds. Without being bound to theory, changing the distance between amide functional groups (i.e., changing the length of the carbon chain in a dithiol monomer) may change crosslinking density and thus may change physical properties such as stiffness and crosslinking density. Therefore, depending on the desired properties of a resulting polymer, different dithiols may be included in the polymer synthesis in order to produce substrates exhibiting a broad spectrum of stiffness and/or elasticity. The relationship between dithiol carbon chain length and substrate stiffness is further described hereinbelow.

The toughness of network polymers can be improved by adding supramolecular interactions (or microstructures) in addition or alternative from crosslinking. For example, additional microstructures may be added to a resulting polymer through interchain hydrogen bonding (H-bonding). In order to obtain microstructures such as crystallinity, the functional core 105 of alkene monomers 102 contains at least one hydrogen bond donor 108 and a hydrogen bond acceptor 110. In FIGS. 1C-IF, the hydrogen bond donor 108 is provided by the amide group(s) nitrogen, and the hydrogen bond acceptor is provided by the amide group(s) carbonyl. When polymerized, the hydrogen bond donor 108 and hydrogen bond acceptor 110 may form hydrogen bonds between different alkene monomers 102. The supramolecular H-bonding may enhance toughness of the resulting network polymer, as well as provide a resulting polymer with varying degrees of crystallinity, which can provide polymers with glassy thermoset-like properties, such as a T_{g} above ambient temperatures, while still achieving ductility, dimensional stability, resistance to heat and solvent, and shape-memory actuation due to the covalently crosslinked polymer networks described herein. By way of example, degree of crystallinity in such a crystalline or semi-crystalline product may be at least 5%, at least 10%, or at least 15% for such materials. Crystallinity may be determined using X-ray diffraction differential scanning calorimetry (DSC), and/or any other mechanism.

Preferred embodiments include amide groups in the alkene monomers 102. Comparing an amide group to other H-bond forming groups such as a urethane group, and without being bound to theory, the carbonyl group in the amide is more electron-withdrawing than other groups so that the proton is more available for forming H-bonds. The stronger H-bonding is evident in the higher melting temperatures (Tₘ) of amides than their urethane counterparts, in mono- and di-functional molecules, and linear polymers. Despite these advantages, the study of network polyamides has been scarce, likely due to synthetic inconvenience. Polyamides are commonly formed by condensation reactions between carboxylic acid (or acid chloride) and amines, or nucleophilic addition of amines to esters (or anhydrides). In both cases, small molecules must be removed to drive the reaction equilibrium towards the formation of high molecular weight polymers. However, the elimination of small molecules can be impractical for synthesizing neat network polymers, since diffusivity becomes prohibited.

As described above, the embodiments disclosed herein overcome at least some of the aforementioned challenges regarding polyamide synthesis by leveraging thiol-ene click chemistry to form polyamide substrates via photopolymerization. Specifically, the reactive groups 106 of the thiol monomers 104 and the reactive groups 106 of the alkene monomers 102 can react with one another, forming a thioether linkage between the alkene monomers 102 to the thiol monomers 104, wherein the thiol-ene conversion reaction (i.e., polymerization reaction) is initiated by a free radical photoinitiator and light irradiation. When the alkene monomers 102 and the thiol monomers 104 are mixed in a vial or other container and melted at about 80° C. (or other applicable melting temperature), they form a stable liquid resin 200 (see FIG. 2B). Because the polymerization reaction is initiated by a free radical photoinitiator and light irradiation (e.g., UV), the liquid resin 200 remains unreacted until a curing process is initiated. This allows for the novel and advantageous manufacturing techniques described below.

FIG. 2C illustrates a schematic of a polymer network 202 formed from the alkene monomers 102 and the thiol monomers 104, wherein the thiol monomers comprise a mixture of dithiol monomers 104′ and trithiol monomers 104″. The reactive groups 106 of alkene monomers 102 can be reacted with the reactive groups 106 of an excess amount of thiol monomers 104 to form the polymer network 202. As is illustrated in FIG. 2C, the dithiol monomers 104′ form linear linkages between connected alkene monomers 102, while the trithiol monomers 104″ provide the resulting polymer network 202 with cross-linking. Interchain hydrogen bonds 204 may form between donor groups 108 and acceptor groups 110 of separate monomers integrated into the polymer chains, resulting in microstructure (e.g., crystallinity) in the polymer network 202.

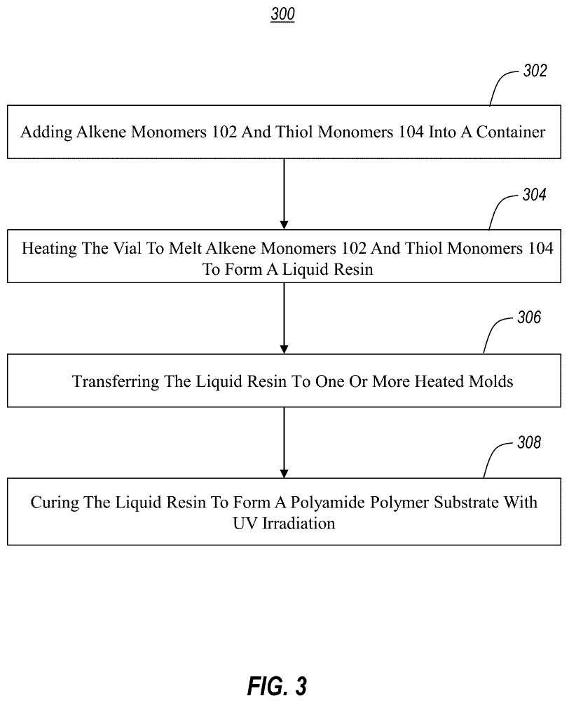

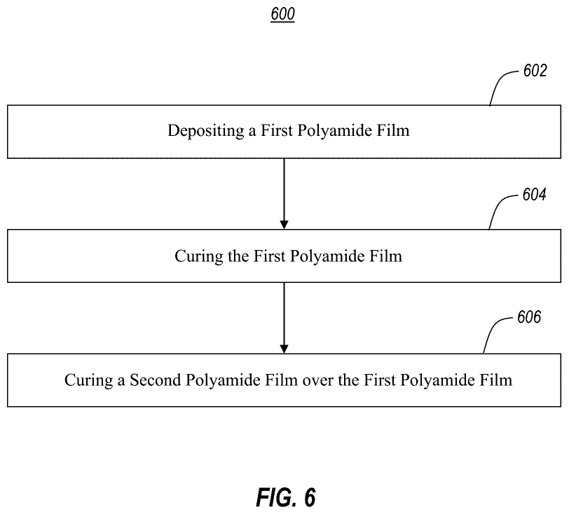

FIG. 3 illustrates method 300, wherein method 300 can be used to synthesize and cure an exemplary polyamide photopolymer, wherein method 300 comprises steps 302, 304, 306 and 308. Step 302 involves adding alkene monomers 102 (e.g., diallyl amide monomers 102) and thiol monomers 104 (e.g., a stoichiometric mixture of EBMP and TEMPIC) into a vial or other container. Step 304 involves heating the monomers to melt alkene monomers 102 and thiol monomers 104 to form a liquid resin (e.g, a mixed composition of such monomers). Step 306 involves transferring the liquid resin to one or more heated molds. The liquid resin formed in step 304 possesses a sufficient pot life (such as from about 2 minutes to about 10 minutes) such that transfer into heated molds can occur without any significant phase separation or solidification. The mold may be heated to a desired temperature, such as about 80° C. Step 308 involves curing the liquid resin to form a polyamide substrate, e.g., using UV irradiation. In one example, the liquid resin is irradiated at 405 nm (5 mW/cm²) at about 80° C. for about 10 minutes to polymerize the resin. More generally, the polymerizing irradiation may be from about 350 nm to about 450 nm, or from about 380 nm to about 430 nm, or from about 390 nm to about 415 nm. The intensity may be from about 1 mW/cm² to about 10 mW/cm², or from about 2 mW/cm² to about 8 mW/cm² or from about 3 mW/cm² to about 6 mW/cm². Curing time may range from about 1 minute to about 30 minutes, from about 3 minutes to about 20 minutes, or from about 5 minutes to about 15 minutes. Curing temperature may be less than about 150° C., less than about 125° C., or less than about 100° C. such as from about 60° C. to about 100° C., from about 70° C. to about 90° C. or about 80° C. When using resins that are liquid at ambient temperatures, the curing and other processing temperatures may be even lower (e.g., about 10° C. to about 40° C., depending on specific melting temperatures). Various other methods of manufacture using the presently described polyamide polymers are also possible, e.g., using additive manufacturing (e.g., a vat polymerization process such as stereolithography, digital light processing, continuous liquid interface production, polyjet, and other techniques that involve the use of photocurable resin materials. FIG. 6 describes a general additive manufacturing process 600 that may include depositing a first polyamide film at 602, curing such film at 604, and optionally depositing and curing a second polyamide film over the first polyamide film at 606. Such method is repeatable using any number of film layers, to form a 3D printed article.

In an embodiment, the polyamide films can undergo transesterification degradation under mild conditions (e.g., at a temperature of no more than about 50° C.). The first and second polyamide films may include diallyl amide or other alkene monomer polymerization residues, thiol monomer polymerization residues, and thioether linkages between the diallyl amide or other alkene monomer polymerization residues and the thiol monomer polymerization residues. the diallyl amide or other alkene monomer polymerization residues and the thiol monomer polymerization residues are polymerized to form any of a wide variety of additive manufactured articles, flexible polymer protective films or membranes.

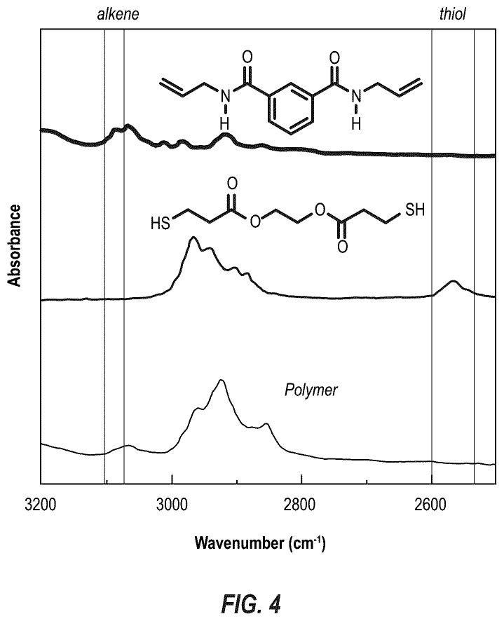

FIG. 4 illustrates results of Fourier-transform infrared (FTIR) spectroscopy, which confirms complete disappearance of the thiol peak (2569 cm⁻¹) and nearly complete disappearance of the alkene peak (3092 cm⁻¹) after UV irradiation. Monitoring the thiol peak by real-time FTIR confirms the rapid polymerization kinetics typical in neat thiol-ene photopolymerization systems, e.g., achieving 63% thiol conversion within 10 seconds with 5 mW/cm² light intensity. The resulting materials were found to be free-standing, glassy, tough, and transparent films, allowing for the films to be readily handled and flexed at ˜200 μm film thickness. More generally, film thickness may be from about 10 μm to about 5000 μm, from about 25 μm to about 3000 μm, from about 50 μm to about 1000 μm, or from about 50 μm to about 500 μm. Thicker structures can be formed by applying and curing successive layers of such resin.

### Material Properties of Various Embodiments

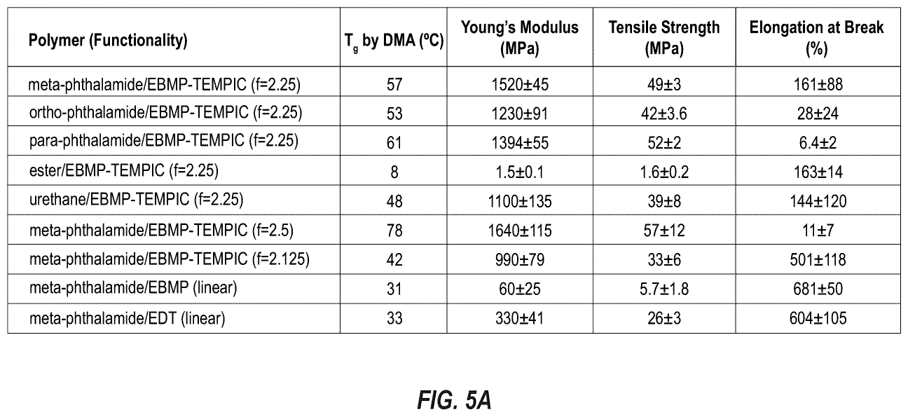

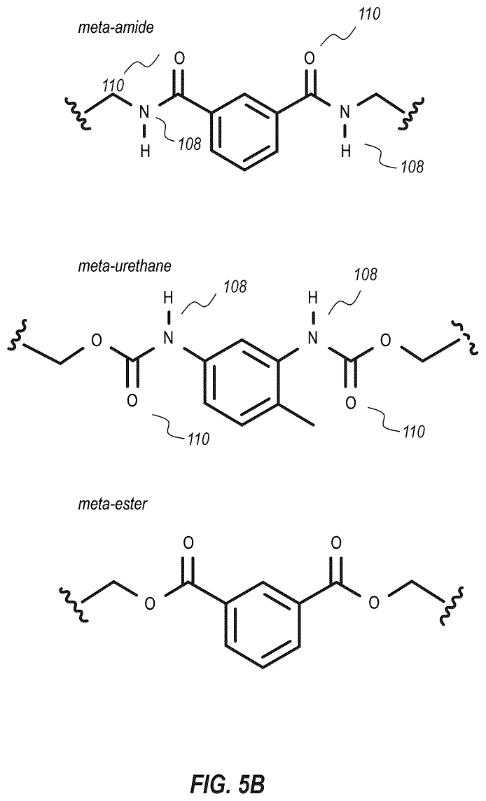

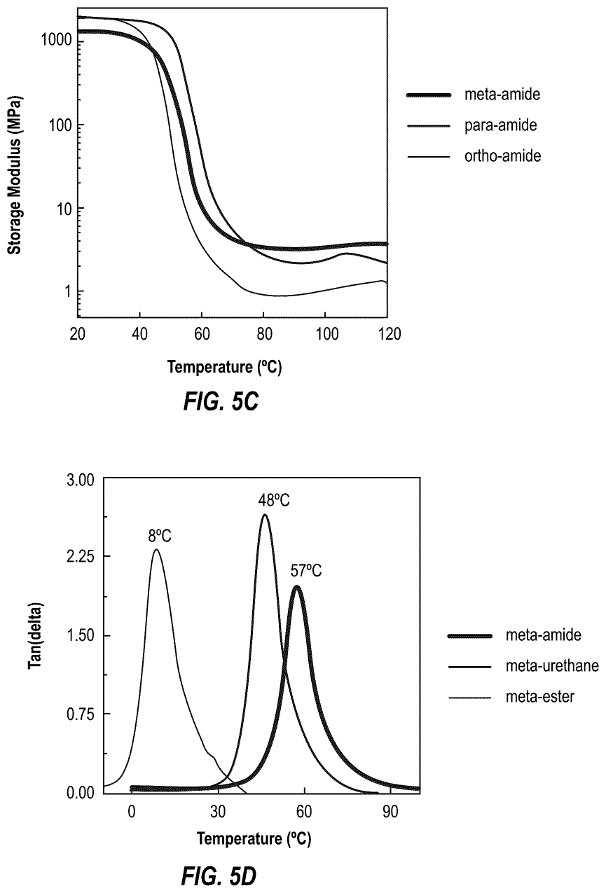

The material properties of exemplary cured polymers were examined, including the glass transition temperature T_{g} by (dynamic mechanical analyzer (DMA)), tensile strength, elongation at break, and Young's modulus. The material properties for polyamides formed from meta-phthalamide and an equal stoichiometric ratio of EBMP and TEMPIC, ortho-phthalamide and an equal stoichiometric ratio of EBMP and TEMPIC, para-phthalamide and an equal stoichiometric ratio of EBMP and TEMPIC are shown in FIG. 5A. FIG. 5A also shows properties for meta-phthalamide and TEMPIC, meta-phthalamide and EBMP and TEMPIC in a 0.25 to 0.75 molar ratio, meta-phthalamide and EBMP, and meta-phthalamide and Ethylene-1,2-dithiol (EDT or 2DT). FIG. 5A also lists material properties of a comparative urethane containing polymer (as opposed to an amide containing monomer) with an equal stoichiometric ratio of EBMP and TEMPIC, and a comparative ester containing monomer with an equal stoichiometric ratio of EBMP and TEMPIC. Further, the results of tests studying the effects of varying different parameters within the polyamide substrates are disclosed herein.

The listed results indicate the meta-phthalamide/EBMP-TEMPIC polymer exhibited unusually high tensile toughness in comparison to the other tested thiol-ene polymers. As shown in FIG. 5A, the different structural isomers of the phthalimide-based monomers, despite being structural isomers, exhibited vastly different material properties. DMA tests showed that the ortho-phthalamide polymer (T_{g}=53° C.) was softer than its meta and para counterparts (T_{g}'s=57° C. and 61° C., respectively). All three polymers are covalently crosslinked networks, showing a rubbery plateau at temperatures above T_{g} (See FIG. 5C, which illustrates storage modulus as a function of temperature). Engineering stress-strain curves obtained by tensile test conducted at ambient conditions (23° C.)) showed that the para-phthalamide polymer behaved like a typical glassy but brittle network polymer, with a tensile strength of 50 MPa, Young's modulus of 1.4 GPa, and an elongation at break of 6%. The ortho-phthalamide polymer showed acceptable toughness with a tensile strength of 42 MPa, Young's modulus of 1.2 GPa, and elongation-at-break of 28%. Without being bound to theory, ortho-phthalamide is believed to form intramolecular H-bonding, which may result in a slightly softer material. Unexpectedly, the meta-phthalamide polymer showed high ductility, with a tensile strength of 49 MPa, Young's modulus of 1.5 GPa, and elongation-at-break of 161%. Strain-hardening was observed at a strain beyond 150%.

As described above, the enhanced H-bonding in amides results in enhanced toughness in comparison to urethanes as well as other polymers with monomers that do not form interchain H-bonds. To study the role of H-bonding in these thiol-ene networks, two control systems comprising a meta-substituted diallyl urethane monomer (urethane polymer) and a meta-substituted diallyl ester monomer (ester polymer) that were each polymerized by thiol-ene photopolymerization with EBMP-TEMPIC thiol monomers were compared to the meta-substituted diallyl amide monomers (amide polymer) that were polymerized by thiol-ene photopolymerization with EBMP-TEMPIC thiol monomers. The structures of each monomer are illustrated in FIG. 5B. The ester polymer was a rubbery material showing a low T_{g} of 8° C. due to the absence of H-bonding; the urethane polymer was glassy, though with a lower T_{g} (48° C.) than that of the amide polymer (see FIG. 5D which illustrates results from a DMA test comparing the meta-ester polymer network, the meta-urethane polymer network, and the meta-amide polymer network). The urethane polymer, although glassy, exhibited lower toughness than the amide polymer. The urethane polymer showed a Young's modulus of about 1.1 GPa, a tensile strength of about 39 MPa, and an elongation-at-break of about 144%, while the amide polymer showed a Young's modulus of about 1.5 GPa, a tensile strength of about 49 MPa, and an elongation at break of about 166%.

In some embodiments, the crosslinking density affected the ductility of the resulting polymer. To test the effect of crosslinking density on ductility, different molar ratios of EBMP and TEMPIC were polymerized with meta-substituted diallyl phtalamide monomers to produce meta-substituted diallyl phthalamide polymer substrates. The material properties of substrates with a molar percentage of 0% EBMP and 100% TEMPIC (f=2.5), 50% EBMP and 50% TEMPIC (f=2.25), 75% EBMP and 25% TEMPIC (f=2.125), 100% EBMP and 0% TEMPIC, and 100% EDT (an alternative dithiol) and 0% TEMPIC were tested and are listed in FIG. 5A.

As the molar percentage of EBMP increased in each polymer substrate, the T_{g} and Young's moduli decreased. Specifically, polymers with 0%, 50%, 75%, and 100% EBMP had T_{g} values of 78° C., 57° C., 42° C., and 31° C., respectively. Young's moduli were 1640 MPa, 1520 MPa, 990 MPa, and 60 MPa, respectively. Accordingly, the polymer with 100% TEMPIC and 0% EBMP was a glassy but brittle polymer. As EMBP percentage increased and TEMPIC decreased, the resulting materials were glassy but advantageously ductile. In some exemplary embodiments, the molar percentage of EBMP may range from about 25% to about 95%, such as from about 40% to about 90%, or from about 50% to about 75%.

It has been observed that adjusting the length of a carbon chain of dithiol compounds used herein can affect the properties of the resulting compound. For example, in embodiments that use diallyl meta-phthalamides as the alkene monomer, a negative correlation between carbon chain length and stiffness was observed between dithiols with C2-C5 carbon chains (e.g., C2 dithiols produced the stiffest polymers) while a positive correlation between carbon chain length and stiffness was observed between dithiols with C6-C10 carbon chains (e.g., C10 dithiols produced the stiffest polymers).

In some embodiments, the polyamide networks are capable of maintaining large deformations while inheriting the ability of elastic recovery. For example, strained meta-phthalamide polymer specimens remained strained for weeks without any noticeable shape recovery, similar to plastic deformations found in thermoplastic polymers. Upon application of gentle heat (close to or above T_{g}), the specimen promptly contracted to its original shape. The recovered specimen could be deformed again, showing nearly identical strength and toughness, after five cycles for the meta-phthalamide/EBMP-TEMPIC (f=2.125) system. Note that the tensile test was stopped at 200% strain to prevent breaking. Interestingly, the large deformation is stable for a long time while the polymer chains are compelled to stay in the strained state. The capability of maintaining large deformations—“apparent plastic deformation”—grants corresponding embodiments with functionality as shape-memory polymers. These embodiments may be used to program at least tensile, compressional and/or torsional deformations, wherein upon application of heat at or near the T_{g} value (e.g., within about 10° C., or within about 5° C. of the T_{g} value) of the material, the original shape is recovered.

In addition, the polyamide substrates disclosed herein resisted creep deformation at elevated temperatures. For example, the polyamide network polymers disclosed herein only exhibited 1.5%-5% creep strain at temperatures from 100° C. to 200° C. for 50 mins.

Typically, glassy thiol-ene network polymers that contain secondary interchain interactions (e.g., H-bonding) may exhibit a dramatic change of tensile properties over time—an “aging” effect. For example, triazole-based thiol-ene polymers became stiffer but brittle in less than one day. Although aging can be reversed by annealing at above T_{g}, the polymers will again age, rendering them impractical for use as materials requiring ductility. The polyamide polymers disclosed herein exhibited aging resistance compared to other thiol-ene polymers wherein the polyamide polymers remained ductile even weeks after they were synthesized.

### Degradable Polyamide Films

Embodiments that include degradable ester linkages allow for simple degradation of the polymer network 202 under mild conditions. For example, the degradable ester linkages 112 may be degraded with a transesterification reaction at or near ambient temperature (i.e., at room temperature).

As discussed above, the polymers described herein are degradable after use. The degradable polyamide substrates described herein may be degraded using a depolymerization reaction under mild conditions (i.e., ambient temperature). The depolymerization reaction may promote transesterification reactions that target the degradable ester linkages in a polyamide photopolymer network. For example, one mild transesterification reaction may involve stimulating the transesterification reaction with a methanol solution comprising potassium carbonate (K₂CO₃) as the catalyst. Other solutions, including other alcohols or other components may also be suitable. Similarly, other salts, metals, or organic bases, e.g., other alkali metal carbonates, alkali hydroxides, or organic bases may also be suitable such as sodium carbonate, strontium carbonate, lithium carbonate, potassium hydroxide, sodium hydroxide, triethylamine (TEA), triazabicyclodecene (TBD), tetramethylguanidine, 1,8-diazabicyclo(5.4.0)undec-7-ene (DBU), zinc (II) acetylacetonate, and/or zinc acetate.

In some instances, to improve mass transport during the reaction, about 50% by volume dichloromethane (DCM) may be added into the methanol solution. The addition of DCM drastically increases the rate of depolymerization. Complete disappearance of the network polymer occurs within 24 hours at ambient conditions for polymers with the same sample dimensions. Other solvents that may be used include, but are not limited to ethanol, 2-proponal, 1-proponal, acetonitrile, chloroform, tetrahydrofuran, acetone, and/or ethyl acetate. In some embodiments, the small molecules produced by the above transesterification reaction can be re-polymerized to reclaim a polyamide network, which could enable a closed loop recycling for ductile, glassy network polymers.

### Example Procedures

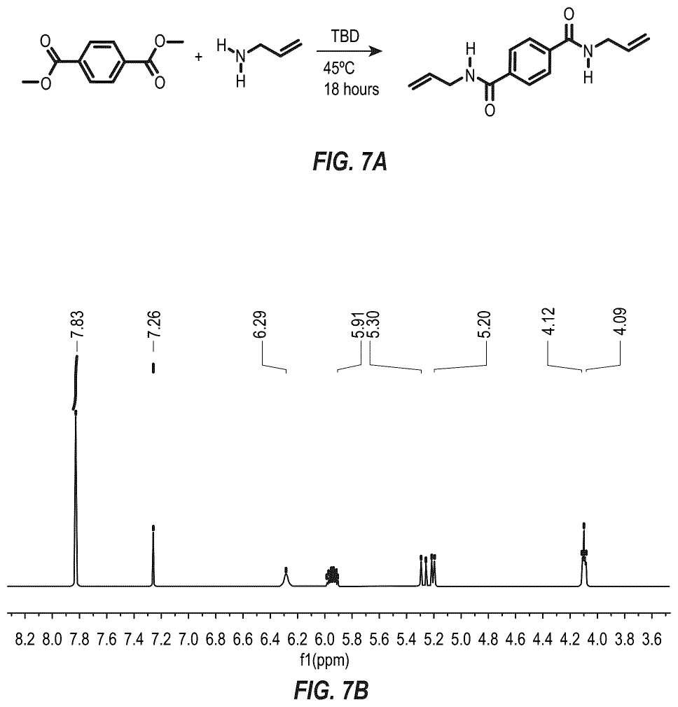

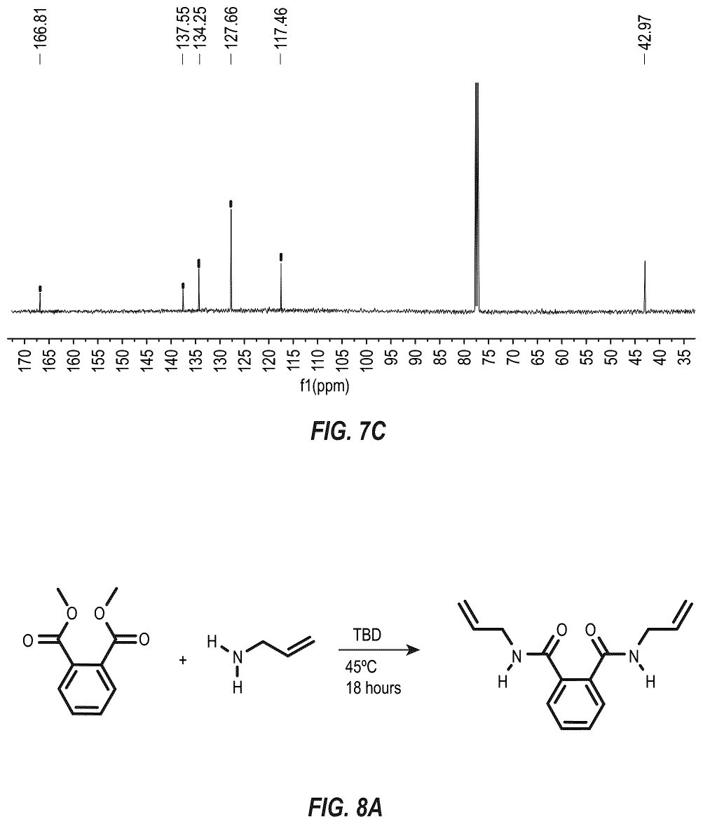

FIG. 7A schematically illustrates an example synthesis used to produce diallyl para-phthalamide monomers. 20 grams (103 mmol) of dimethyl terephthalate and 0.1 gram (1 mmol) of 1,5,7-triazabicyclo[4.4.0]dec-5-ene (TBD) were placed in 100 mL round bottom flask. 23.2 mL (309 mmol) allylamine were added to the flask. The cloudy mixture was allowed to be magnetically stirred at 45° C. for 18 hours. Solid product was washed twice with 200 mL of ethyl acetate and dried at 80° C. for 12 hours to give an off white powder (21 grams). Yield: 83%. Melting Point (M.P., by DSC): 236° C. Fourier transform infrared (FTIR) (ATR): ν=3292 (N—H), 3074, 2980, 2918, 2865 (C—H), 1627, 1540 (C═O), 1410, 1290, cm-1. 1H NMR (500 MHz, CDCl₃) δ 7.83 (s, 4H), 6.29 (s, 2H), 6.00-5.89 (m, 2H), 5.3-5.2 (m, 4H), 4.10 (t, J=5.9 Hz, 4H). 13C NMR (126 MHz, CDCl₃) δ 166.80, 137.54, 134.25, 127.66, 117.46, 42.98. FTIR, ¹H-NMR, and ¹³C-NMR confirm successful synthesis of diallyl para-phthalamide monomers as shown in FIGS. 7B-7C.

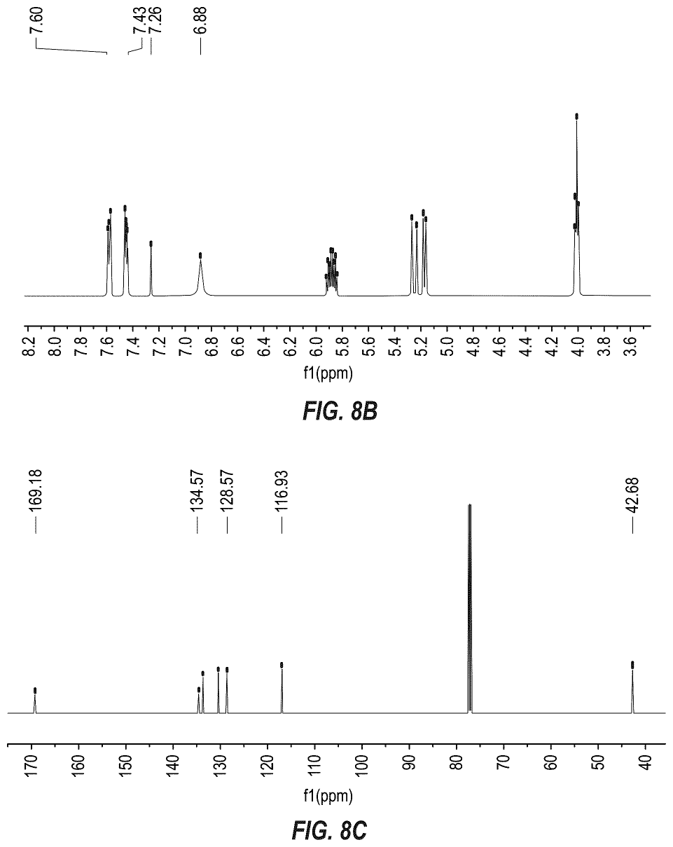

FIG. 8A schematically illustrates an example synthesis used to produce diallyl ortho-phthalamide monomers. 20 grams (103 mmol) of dimethyl phthalate and 0.1 gram (1 mmol) of TBD were placed in 100 mL round bottom flask. 23.2 mL (309 mmol) allylamine were added to flask. The mixture was stirred at 45° C. for 18 hours starting out clear and product precipitating out by the end. 100 mL ethyl acetate was added to the flask which was then placed in the freezer to precipitate product out. Product was then recrystallized in ethyl acetate (250 mL) and dried at 80° C. for 12 hours to give an off white crystal product (20.6 grams). Yield: 82%. M.P 144° C. Fourier transform infrared (FTIR) (ATR): ν=3227 (N—H), 3065, 2981 (C—H), 1645, 1623, 1589, 1545 (C—O), 1422, 1346, 1303, cm-1. 1H NMR (500 MHz, CDCl3) δ 7.z58 (d, J=5.7 Hz, 2H), 7.45 (d, J=5.7 Hz, 2H), 6.88 (s, 2H), 5.94-5.82 (m, 2H), 5.27-5.16 (m, 4H), 4.01 (t, J=5.8 Hz, 4H). 13C NMR (126 MHz, CDCl₃) δ 168.93, 134.32, 133.43, 130.15, 128.32, 116.68, 42.43. FTIR, ¹H-NMR, and ¹³C-NMR confirm successful synthesis of diallyl ortho-phthalamide monomers as shown in FIGS. 8B-8C.

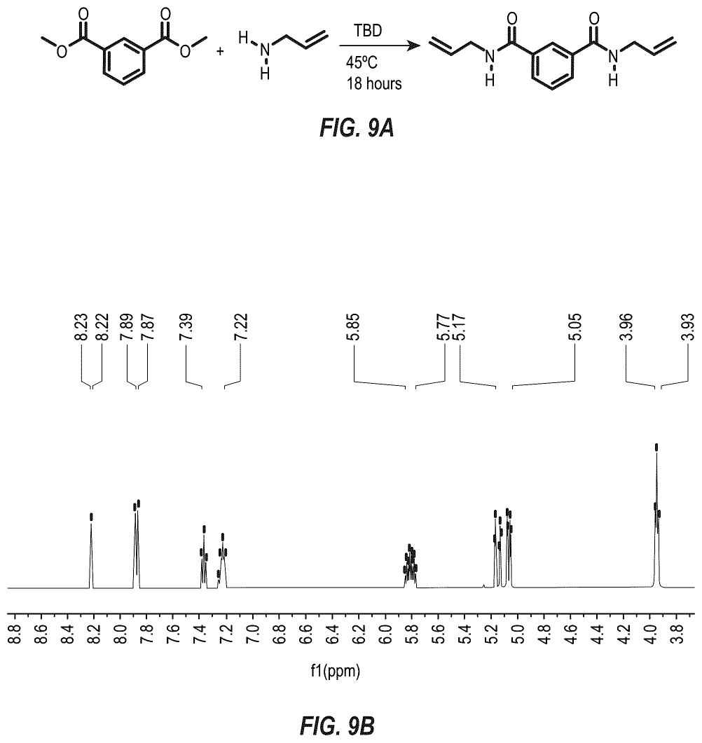

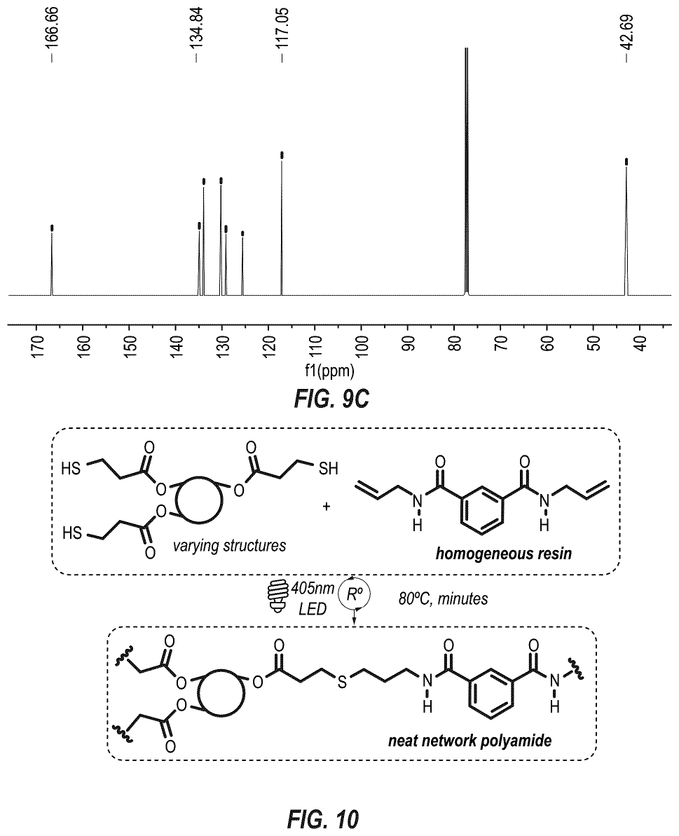

FIG. 9A schematically illustrates an example synthesis used to produce diallyl meta-phthalamide monomers. 100 grams (515 mmol) of dimethyl isophthalate and 0.5 gram (5 mmol) of TBD were placed in a 500 mL round bottom flask. 116 mL (1.55 mol) allylamine were added to the flask. Flask was stirred at 45° C. for 18 hours becoming clear once heated. 200 mL ethyl acetate was added to the flask then placed in the freezer to precipitate product out. Product was then recrystallized in ethyl acetate (400 mL) and dried at 80° C. for 12 hours to give an off white crystal product (103.4 grams). Yield: 82%. M.P 123° C. Fourier transform infrared (FTIR) (ATR): ν=3303, 3242 (N—H), 3065, 2982, 2914 (C—H), 1630, 1580, 1528 (C═O), 1419, 1261, cm-1. 1H NMR (500 MHZ, CDCl3) δ 8.2 (s, 1H), 7.93 (d, J=7.7 Hz, 2H), 7.53 (t, J=8.3 Hz, 1H), 6.35 (s, 2H), 6.00-5.87 (m, 2H), 5.33-5.11 (m, 4H), 4.09 (d, J=5.8 Hz, 4H). 13C NMR (126 MHz, CDCl₃) δ 166.92, 135.10, 134.18, 130.43, 129.34, 125.74, 117.30, 42.95. FTIR, ¹H-NMR, and ¹³C-NMR confirm successful synthesis of diallyl meta-phthalamide monomers as shown in FIGS. 9B-9C.

FIG. 10 schematically illustrates an example polymerization reaction used to produce and cure a poly meta-phthalamide substrate. 1 gram (4.1 mmol) of meta-phthalamide monomer, 0.51 grams (2.05 mmol) of ethylene bis(3-mercaptopropionate) (EBMP), 0.75 grams (0.136 mmol) of tris[(3-mercaptopropionyloxy)-ethyl]-isocyanurate (TEMPIC), and 0.022 grams (0.063 mmol) of diphenyl(2,4,6-trimethylbenzoyl) phosphine oxide (TPO) were added to a 20 mL scintillation vial. The thiol MW values were obtained from Bruno Bock using the thiol functional group per molecular weight values. The vial was warmed slowly to melt the phthalamide monomer and mixed. Melted resin was then added to preheated molds in an 80° C. UV curing oven (Form Cure). The samples were cured for 10 minutes at 405 nm wavelength with 5 mW/cm² light intensity (measured by Thorlabs PM100D optical power meter equipped with a standard photodiode S120VC sensor). All other thiol-ene polymerizations disclosed herein were carried out similarly.

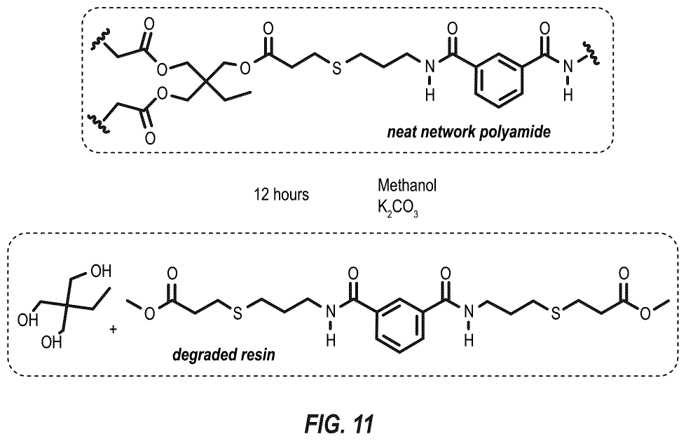

FIG. 11 schematically illustrates an exemplary depolymerization reaction used to degrade a poly meta-phthalamide substrate. A saturated potassium carbonate (K₂CO₃) methanol solution was prepared by adding 10 mg K₂CO₃ per mL of methanol and allowed to dissolve overnight. 10 mL of the solution was then added to 0.2 gram of the bulk polymer sample. The polymer sample disappeared overnight. Subsequently, methanol was removed, dichloromethane (DCM) and water were added. The small molecules from the degraded polymer were extracted by collecting the DCM layer. Removal of DCM yielded viscous yellow oil.

Without departing from the spirit and scope of this invention, one of ordinary skill can make various modifications to the invention to adapt it to various usages and conditions. As such, these changes and modifications are properly, equitably, and intended to be, within the full range of equivalence of the following claims,

What is claimed is:

1. A polyamide substrate formed from a crosslinked polymer that contains one or more thioether linkages and one or more amide linkages in repeating units of the polymer, wherein the thioether linkages and the amide linkages are introduced by polymerizing from:
one or more alkene monomers;
one or more thiol monomers;
wherein thioether linkages are present between polymerization residues of the one or more alkene monomers and the one or more thiol monomers,
wherein the one or more alkene monomers and the one or more thiol monomers polymerize to form the polyamide substrate, and
wherein the one or more thiol monomers comprise ester linkages, wherein the ester linkages are degradable under mild conditions.

2. The polyamide substrate of claim 1, wherein the one or more alkene monomers comprise at least one of allyl ether, vinyl ether, allyl ester, norbornene, acrylate, methacrylate, epoxy, diallyl meta-phthalamide, diallyl ortho-phthalamide, diallyl para-phthalamide, N-allyl-4-pentenamide (N7), N-allyl-3-butenamide, N-vinyl, N-allyl-5-hexenamid, or another alkyl divinyl amide monomer.

3. The polyamide substrate of claim 1, wherein the one or more thiol monomers comprise dithiol monomers, trithiol monomers, or a mixture thereof.

4. The polyamide substrate of claim 1, wherein the one or more thiol monomers comprise at least one of ethylene bis(3-mercaptopropionate) (EBMP), tris [2-(3-mercaptopropionyloxy) ethyl] isocyanurate (TEMPIC), ethane-1,2-dithiol (EDT), 1,2 ethylene dithiol (2DT), 1,3 propanedithiol (3DT), 1,4 butanedithiol (4DT), 1,5 pentanedithiol (5DT), 1,6 hexanedithiol (6DT), 1,7 heptanedithiol (7DT), 1-8 octanedithiol (8DT), 1-9 nonanedithiol (9DT), 1-10 dodecanedithiol (10DT), or trimethylolpropane tris(3-mercaptopropionate) (TMPMP).

5. The polyamide substrate of claim 1, wherein the polyamide substrate is crystalline or semi-crystalline.

6. The polyamide substrate of claim 1, wherein the polyamide substrate is capable of maintaining large plastic deformations of greater than about 200% strain.

7. The polyamide substrate of claim 6, wherein the polyamide substrate exhibits shape memory after application of heat within about 10° C. of a T_{g} value of the polyamide substrate.

8. The polyamide substrate of claim 1, wherein the polyamide substrate has a T_{g} value ranging from about 30° C. to about 70° C.

9. A method of synthesizing and curing a polyamide substrate, the method comprising:
providing diallyl amide or other alkene monomers and thiol monomers;
the diallyl amide or other alkene and thiol monomers being present as a liquid resin comprising diallyl amide or other alkene monomers and thiol monomers;
optionally transferring the liquid resin to a mold; and
curing the liquid resin with UV light, visible light, heat, and/or a thermal radical generating catalyst.

10. The method of claim 9, wherein the diallyl amide or other alkene and thiol monomers are heated to present them as a liquid resin.

11. The method of claim 9, wherein at least one of (i) the diallyl amide or other alkene and monomer or (ii) the thiol monomers liquid at ambient temperature so that no heating is necessary to present as a liquid resin.

12. The method of claim 9, wherein the liquid resin has a pot life ranging from about 2 to about 10 minutes.

13. The method of claim 9, wherein the thiol monomers comprise a mixture of dithiol monomers and trithiol monomers.

14. The method of claim 13, wherein the trithiol monomers make up greater than 0 mol % to about 75 mol % of the thiol monomers and wherein the dithiol monomers make up about 25 mol % to less than 100 mol % of the thiol monomers.

15. The method of claim 13, wherein the trithiol monomers comprise TMPMP.

16. The method of claim 9, wherein the method does not involve using or removing a solvent.

17. The method of claim 9, wherein the diallyl amide monomers comprise meta-phthalamide monomers.

18. The method of claim 9, wherein the diallyl amide monomers comprise alkyl divinyl amide monomers including an asymmetrically positioned amide group.

19. A method of additive manufacturing, the method comprising:
depositing and curing a first polyamide film;
optionally depositing and curing a second polyamide film over the first polyamide film,
wherein the method is repeatable to form a 3D printed article, and
wherein the polyamide films can undergo transesterification degradation at a temperature of no more than about 50° C.

20. The method of claim 19, wherein the first polyamide film and the optional second polyamide film comprise:
diallyl amide or other alkene monomer polymerization residues;
thiol monomer polymerization residues; and
thioether linkages between the diallyl amide or other alkene monomer polymerization residues and the thiol monomer polymerization residues,
wherein the diallyl amide or other alkene monomer polymerization residues and the thiol monomer polymerization residues are polymerized to form a flexible polymer substrate.

21. The method of claim 19, wherein the first polyamide film comprises diallyl amide monomers comprise:
diallyl amide or other alkene monomer polymerization residues;
thiol monomer polymerization residues; and
thioether linkages between the diallyl amide or other alkene monomer polymerization residues and the thiol monomer polymerization residues;
wherein the diallyl amide or other alkene monomer polymerization residues and the thiol monomer polymerization residues are polymerized to form a flexible polymer protective film or membrane.
